(19) United States
(12) Patent Application Publication
(10) Pub. No.: US 2021/0146673 A1
(43) Pub. Date: May 20, 2021

(54) METHOD FOR CONNECTING AN ATTACHMENT PART TO A SANDWICH COMPONENT, USE OF A POLYMER COMPOSITION, AND COMPOSITE COMPONENT

(71) Applicant: NOLAX AG, Sempach Station (CH)

(72) Inventors: Thomas WOLF, Neudorf (CH); Patrick STEINER, Schattdorf (CH); Marcel FISCHER, Rain (CH)

(21) Appl. No.: 16/620,551

(22) PCT Filed: Jun. 7, 2018
(86) PCT No.: PCT/EP2018/065024

§ 371 Date: Dec. 9, 2019

(30) Foreign Application Priority Data
Jun. 12, 2017 (EP) 17175456.7

(51) Int. Cl. B32B 37/12; B32B 3/26; F16B 11/00

(52) U.S. Cl. CPC B32B 37/12; F16B 11/006; B32B 3/266

(57) ABSTRACT

A method for connecting an attachment part (3) to a sandwich component (2). The method comprises the following steps: providing a sandwich component (2); providing an attachment part (3) having at least one fill opening (31); joining the attachment part (3) to the sandwich component (2) such that the first fill opening (31) of the attachment part (3) and at least one opening (24) of the sandwich component (2) are arranged in a communicating manner. Introducing a polymer composition (4) into the at least one opening (24) of the sandwich component (2), via the first fill opening (31) of the attachment part (3), such that, after the polymer composition (4) has cured, the attachment part (3) and the sandwich component (2) are connected to one another by the polymer composition (4). The use of a polymer composition (4) and a composite component (1) are also disclosed.

The invention relates to a process for the connection of an add-on part to a sandwich component, to the use of a polymer composition and to a composite component as in the preambles of the independent claims.

As a connection method, sandwich construction is a type of lightweight construction in which the components consist of strong load-bearing outer plies separated by a relatively soft, mostly low-density, core material (interlayer). These parts have low weight and are very resistant to bending and buckling. Calculations relating to same in the construction industry are based on linear sandwich theory. The core can by way of example consist of paper honeycombs, metal honeycombs, in particular aluminum honeycombs, foam materials, for example rigid foam, mineral wool or balsa wood. It transmits shear forces that arise, and supports the outer plies. Other frequently utilized properties of these very low-density core materials are thermal insulation and acoustic insulation. Materials used as outer plies are inter alia sheet metal, metals such as aluminum, chromium-nickel/galvanized steel, fiber-composite materials; plastics such as polypropylene (PP), polyvinyl chloride (PVC), polysulfone (PS), polyurethane (PUR); fiber-reinforced plastics such as glassfiber-reinforced plastic (GRP), aramid, carbon-fiber-reinforced plastic (CRP); wood-derived materials such as (ply) wood, high-density fiberboard (HDF); mineral materials, in particular glass; stone. Reinforcing elements are often provided to locations where forces are introduced.

Connection of sandwich components to other components is achieved with use of commercially available solutions using reinforcing elements, for example what are known as inserts, which are introduced into the sandwich structure, or what are known as onserts, which are applied onto the sandwich structure. In relation to force transmission, a fundamental distinction must be made between force transmission from the mechanical connection means to the insert or onsert and force transmission from the insert or onsert to the actual component.

A disadvantage of commercially available elements for introducing local forces into lightweight construction materials, in particular blind fastening elements in sandwich panels or in sandwich components is that the insert or onsert for introduction of the force must be introduced manually, because automation is complicated. This results in high process costs and low process reliability. Another disadvantage is that, from the manufacturer's point of view, use of standardized connection means greatly restricts product design and component flexibility.

It is therefore an object of the invention to overcome the disadvantages of the prior art. In particular, it is an object of the invention to provide, for connection of a sandwich component to an add-on part, a process that can be automated and is quick and inexpensive and ensures secure connection between sandwich component and add-on part. Another object of the invention is to produce a composite component which has low production cost and has good composite properties.

These objects are achieved via the features of the independent claims.

The invention relates to a process for the connection of an add-on part to a sandwich component. The process comprises the step of provision of a sandwich component. The sandwich component comprises a first main surface with a first outer ply and a second main surface with a second outer ply, in particular a first outer sheet and a second outer sheet. The first outer ply and/or the second outer ply has/have at least one aperture. The sandwich component comprises at least one interlayer, where the interlayer is positioned between the first outer ply and the second outer ply. The thickness of the interlayer therefore corresponds to the distance between the first outer ply and the second outer ply.

The process moreover comprises the steps of provision of an add-on part with at least one input aperture, and also joining of the add-on part to the sandwich component. In the joining procedure, the first input aperture of the add-on part and the at least one aperture of the sandwich component are arranged in communication. A hardenable polymer composition is introduced by way of the first input aperture of the add-on part into the at least one aperture of the sandwich component in a manner such that, after hardening of the polymer composition, the add-on part and the sandwich component are connected to one another by the polymer composition.

The expression “in communication” here means that the polymer composition can pass by way of the input aperture of the add-on part into the aperture of the sandwich component.

The expression “main surfaces of the sandwich component” means the large-surface-area sides which are not formed by the interlayer. The main surfaces are therefore those surfaces of the outer plies that face away from the interlayer.

This method permits connection of a sandwich component to an add-on part without any need for additional connection means, for example screws, but nevertheless with formation of a secure connection. The polymer composition can by way of example be injected. Automated procedures can be used. The physical properties of the location of force introduction, and therefore those of the component, can be optimized by appropriate adjustment of the properties of the polymer composition. It is moreover possible to adjust hardness properties and elasticity properties within a connection location in order to achieve optimized introduction of force into the component structures. This is advantageous in particular for dynamic loads.

The polymer composition can have the following characteristics, depending on the load and materials involved:
a) It can extend only at most as far as a first-outer-ply surface facing toward the interlayer. The forces are therefore transferred only to a minimal extent into the interlayer and to the opposite outer layer. This reduces the risk that the connection becomes visible on, or apparent at, the opposite second outer ply.
b) It can extend into the interlayer without affecting a second-outer-ply surface facing toward the interlayer. This has the advantage that the forces are transmitted to the interlayer, but the second outer ply remains unaffected and unaltered.
c) It can extend as far as the second-outer-ply surface facing toward the interlayer, or through the second outer ply. The forces can thus be dissipated by way of both outer plies.

The manner of introduction of the polymer composition is particularly preferably such that the polymer composition projects particularly deeply into the interlayer, i.e. reaches a point particularly close to the opposite outer ply. This results in anchoring of the hardened polymer composition in the sandwich component. The anchoring preferably extends through at least 10% of the thickness of the interlayer.

It is also possible that the first outer ply and the second outer ply respectively have at least one aperture and that the at least aperture of the first outer ply and the at least one aperture of the second outer ply are arranged in communication with at least one input aperture of the add-on part.

The first input aperture can lead to a cavity between the add-on part and the sandwich component. The cavity arises when the two components are joined, and is formed by the at least one input aperture in the add-on part and the at least one aperture in the sandwich component. On introduction of the polymer composition, the cavity can be filled with the polymer composition by way of the input aperture. It is also possible that the add-on part has more than one input aperture. A plurality of input apertures can lead into the same cavity and can be arranged in communication with an aperture in the sandwich component. It is also conceivable that an input aperture of the add-on part is arranged in communication with two or more apertures in the sandwich component. The apertures in the sandwich component here can be arranged in the first outer ply and/or in the second outer ply. However, it is also possible that a plurality of cavities are formed between the sandwich component and the add-on part, on joining, and that a respective input aperture leads into each of the cavities.

The cavity permits joining of the components by way of adhesion surfaces of the components, through adhesive bonding by means of a polymer composition.

The hardenable polymer composition is preferably an adhesive, in particular a two-component adhesive.

The polymer composition can be selected in accordance with the formulations disclosed in EP 2 589 478 A1. These are incorporated herein by way of reference. The polymer composition is in particular an adhesive with the following properties. The adhesive is preferably a rapid-hardening two-component adhesive based on polyurea as described in EP 1 958 975 B1 or EP 2 871 194. These are incorporated herein by way of reference.

It is preferable that the polymer composition comprises an isocyanate-containing component A and an amine-containing component B. Component A comprises an isocyanate-terminated prepolymer with isocyanate functionality 1.7, preferably where 1.7<f_{NCO}<3, particularly preferably in the range from 2 to 3.

Component B comprises at least one di- and/or polyamine, preferably a polyetherdiamine and/or polyether polyamine. The stoichiometric ratio of isocyanate groups in component A to amine groups in component B here is 0.5 to 1.2, particularly preferably 1.

It is particularly preferable that the polymer composition comprises a first component A and a second component B. Component A comprises a monomeric polyisocyanate, in particular monomeric diisocyanate, and an isocyanate-terminated prepolymer and/or a prepolymer mixture with isocyanate functionality 1.7, preferably in the range 1.7<f_{NCO}<3, particularly preferably in the range 2<f_{NCO}<3. The second component B comprises a di- and/or polyamine, in particular a polyetherdiamine and/or a polyether polyamine, and a trimerization catalyst. The stoichiometric ratio of isocyanate groups in the first component A to isocyanate-reactive hydrogen atoms in the second component B present in the composition is 7.5 to 25, preferably 10 to 20, particularly preferably 15. A two-component polymer composition is therefore used, where a second prepolymer is formed in a first step by way of a reaction of the polyamine with the monomeric polyisocyanate (in particular the diisocyanate) present in excess. This reaction is highly exothermic. At the same time, the amines provided in component B crosslink the isocyanate-terminated prepolymer of component A. The further course of the reaction mainly involves trimerization of the isocyanate groups present, under the influence of relevant catalysts, in particular potassium octanoate. In contrast to conventional polyurethane adhesives and polyurea adhesives, the polymer composition therefore has not only higher tensile strength and heat resistance than other high-strength adhesives, for example epoxy resins, but also has higher impact resistance.

It is also possible in principle to use other two-component liquid adhesives based on polyurethane, epoxy or acrylate that harden to give thermosets. The adhesive is described as liquid if its viscosity during application in accordance with instructions is <10000 mPas, preferably <300 mPas, ideally <100 mPas (measured in the mixing head of the applicator at 35° C.-65° C., preferably 50° C., and at a pressure of 70-140 bar, preferably 100 bar). This mixing viscosity can be further optimized through selection of the temperature of the components. The viscosity was determined by the Brookfield method with spindle 4 and with rotation rate 20 rpm.

“Hardening” in this context means chemical solidification of the adhesive by chain polymerization, polycondensation or polyaddition. A polymer composition is thus provided that sets rapidly, in particular by chemical reaction, and is structurally robust.

A polymer composition is thus introduced which, after solidification, is structurally robust and in particular non-expanding. Because the polymer composition has exothermic properties, regions of the interlayer and/or of existing adhesive layers of the sandwich component can be melted during reaction of the polymer composition. Anchoring of the polymer composition is thus improved.

The pot life of the hardenable polymer composition can be in the range from 1 to 15 sec, preferably 2 to 10 sec, particularly preferably 3 to 7 sec.

This type of polymer composition has the advantage that the composite made of sandwich component and add-on part can immediately be further processed or used for the intended use, because within a very short time the polymer composition has the necessary strength. By way of example, a robust connection to another component can be produced.

The expression “pot life” means, in accordance with DIN EN 923:1998-05, the period within which a multicomponent adhesive can be used after mixing. Pot life was determined by “Method 3: Determination by manual application” of DIN EN 14022:2010 (German version). The short reaction time of the system must, of course, be taken into account here.

The polymer composition can moreover form a coherent, i.e. adhesive, and/or interlocking and/or frictional connection. It is preferable that the coherent connection is formed between the polymer composition and the interlayer and/or the first outer ply and/or the second outer ply after the polymer composition has hardened. Again, by virtue of this embodiment particularly large forces are introduced and dissipated to the outer plies.

The polymer composition can form an undercut in the sandwich component. It is preferable here that the undercut is formed at the first outer ply and/or the second outer ply, particularly at that surface of the first outer ply and/or of the second outer ply that faces toward the interlayer. It is preferable that the undercut is formed by the polymer composition in the hardened state. It is thus possible to form an interlocking connection between the polymer composition and the first and/or second outer ply, thus permitting introduction of particularly large forces and dissipation of same to the outer plies.

The polymer composition can have an undercut in the add-on part. The undercut is preferably formed by the polymer composition in the hardened state. By way of example, the add-on part can be another sandwich component. It is thus possible by way of example to form an interlocking connection between the polymer composition and the add-on part, thus permitting introduction of particularly large forces and dissipation of same, to the add-on part.

The undercuts can be present either in the sandwich component or in the add-on part or in both components. If the undercuts are present in both components, these can be utilized to dissipate the forces to both components. This permits acceptance of larger forces.

Within the sandwich component, the polymer composition can extend across a maximal distance in a direction parallel to the main surfaces of the sandwich component that is greater than the maximal diameter of the aperture of the sandwich component. The maximal distance across which it extends here is the distance across which the polymer composition extends in the hardened state. It can extend across this distance in structured or unstructured form. The word “structured” here refers to the possibility that it can extend across said distance in particular shapes. By way of example, it can extend across said distance in a star shape. Other conceivable shapes are oval, rectangular, square and triangular. It is also possible, however, that the material of the interlayer allows it to extend across said distance in unstructured manner. By way of example, in a loosely packed material it is possible that cavities between the material are filled until the polymer hardens without formation of specifically definable shapes.

By extending across said distance in this manner, the polymer composition becomes ideally anchored within the sandwich component, thus providing a particularly stable and robust composite made of sandwich component and add-on part.

The aperture of the sandwich component can be selected from the group of slot and hole, in particular circular hole. These can be introduced mechanically by drilling, milling, punching, slotting, perforation, lasering, grinding, cutting, or a chemical or thermal method. Possibilities here are one aperture, a plurality of apertures, and a plurality of comparatively small apertures, these being round, polygonal or slot-like. Undefined shapes are likewise possible. In this way, the polymer composition can be introduced particularly advantageously into the interlayer.

Specialized tooling can be used for the production of undercuts, for example milling machines, drills or cutters.

Selection of the aperture as a non-round aperture, for example as a slot, provides a connection point that ensures an interlocking connection to prevent undesired rotation of the solidified polymer composition. It is thus possible to accept relatively large forces.

Selection of small, narrow, apertures can permit concealed assembly.

The at least one interlayer has a hollow-chamber structure. The expression “hollow-chamber structure” here can be either a single chamber or else a plurality of chambers. The hollow-chamber structure can by way of example comprise honeycombs, corrugations, pores, ribs, fillets, pyramids or hemispherical structures. However, other structures are also conceivable. The individual chambers can be filled with a material, or can comprise a gas or gas mixture, therefore appearing to be “unfilled”. The chambers can also have alternating filled and unfilled regions. If the chambers are unfilled, adhesion can be achieved by means of frictional connection and/or interlocking connection and/or coherent connection. Coherent connection can be achieved chemically by way of molecular forces and/or physically by binding to the surface of the material.

If, by way of example, the hollow-chamber structure is a honeycomb structure, it is possible that individual honeycombs are filled and that individual honeycombs comprise only a gas or gas mixture, for example air. It is also conceivable that the individual honeycombs are filled only partially, for example half-filled, with a material, and that the remaining portion comprises a gas mixture, for example air. Similar considerations can apply to the other hollow-chamber structures mentioned.

The hollow-chamber structure of the interlayer can reduce the weight of the sandwich component while nevertheless providing very high stability.

Filled and unfilled hollow-chamber structures are possible. The material can preferably be selected from paperboard, plastic, metal, fiber-composite material, wood-derived material, foam material, fiber material and loose material made of plastics such as polyvinyl chloride (PVC), polyethylene terephthalate (PET), polymethacrylimide (PMI), expanded polystyrene (EPS), extruded polystyrene foam (XPS), recycled material, wood-derived materials such as balsa wood, soft fibers, turnings, fiber material, composite material, tubular swarf, lightweight solid wood board; glass; stone; metals such as aluminum.

The outer plies of the sandwich component can preferably be selected from metal such as aluminum, chrome-nickel/galvanized steel; plastics such as polypropylene (PP), polyvinyl chloride (PVC), polysulfone (PS), polyurethane (PUR); fiber-reinforced plastics such as glassfiber-reinforced plastic (GRP), aramid, carbon-fiber-reinforced plastic (CRP); wood-derived materials such as plywood, high-density fiberboard (HDF); mineral materials, in particular glass; stone.

The add-on part can be a sheet, a connecting element and/or fastening element; a spring system; an electrical element or a covering. A sheet can by way of example be an adapter sheet or another sandwich component. If it is another sandwich component, this can likewise have the properties set out above. The connecting element and/or fastening element can be a profile, angle, tube, sleeve, nut or covering. Conceivable electrical elements are by way of example modules, boxes, consoles or lighting installations.

In this way it is possible to apply a wide variety of different components to the sandwich component. The sandwich component can be used in many different ways.

Another aspect of the invention provides the use of a polymer composition for the connection of an add-on part to a sandwich component, preferably in a process as described above.

It is preferable that the polymer composition is a chemically crosslinkable adhesive, in particular a single-component or two-component adhesive, or a hotmelt adhesive, in particular a thermoplastic.

In particular, the adhesive can be configured as already set out above.

It is very particularly preferable that the polymer composition comprises an isocyanate-containing component A and an amine-component B. The component A comprises an isocyanate-terminated prepolymer with isocyanate functionality 1.7, preferably where 1.7<f_{NCO}<3, particularly preferably in the range from 2 to 3. Component B comprises at least one di- and/or polyamine, preferably a polyetherdiamine and/or polyetherpolyamine. The stoichiometric ratio of isocyanate groups in component A to amine groups in component B is preferably 0.5 to 1.2, and particularly preferably 1.

In contrast to conventional polyurethane adhesives and polyurea adhesives, this type of polymer composition has not only higher tensile strength and heat resistance than other high-strength adhesives, for example epoxy resins, but also higher impact resistance.

A further aspect of the invention relates to a composite component comprising a sandwich component and an add-on part. The sandwich component has at least one preformed aperture in a first main surface with a first outer ply and/or in a second main surface with a second outer ply. The add-on part has a preformed input aperture. The aperture of the sandwich component and the input aperture of the add-on part are arranged in communication and connected to one another by way of a hardened polymer composition. The sandwich component and the add-on part are preferably designed as set out above.

The composite component is preferably obtainable via a process as described above.

This type of composition component can be used in many different ways, for example in the field of road traffic, in particular for commercial vehicles, cars, Formula 1, motorhomes, two/three wheelers, temporary road surfaces; in the field of railroad traffic, in particular train, tram, cable cars; air travel, and in particular space travel, aircraft, drones, satellites; marine, in particular yacht and super yacht, river boats, freighters, cruise ships, oil platforms, offshore installations, underwater applications; construction, in particular facades and roofs, floors, bridges, elevators, escalators, mobile housing; interior fitting-out, in particular furniture, ceilings, walls, floors, shopfitting, fitting-out of exhibition stands, stage construction, display, doors, partitions; sports, in particular winter sports and watersports; logistics, in particular containers, tanks, pallets, packaging; energy, in particular wind turbines, solar installations; mechanical engineering, in particular stamping tools, cladding, moving parts; medicine, in particular dental implants, other implants, fixings; defense technology, in particular rockets.

The invention is described in more detail below with reference to examples.

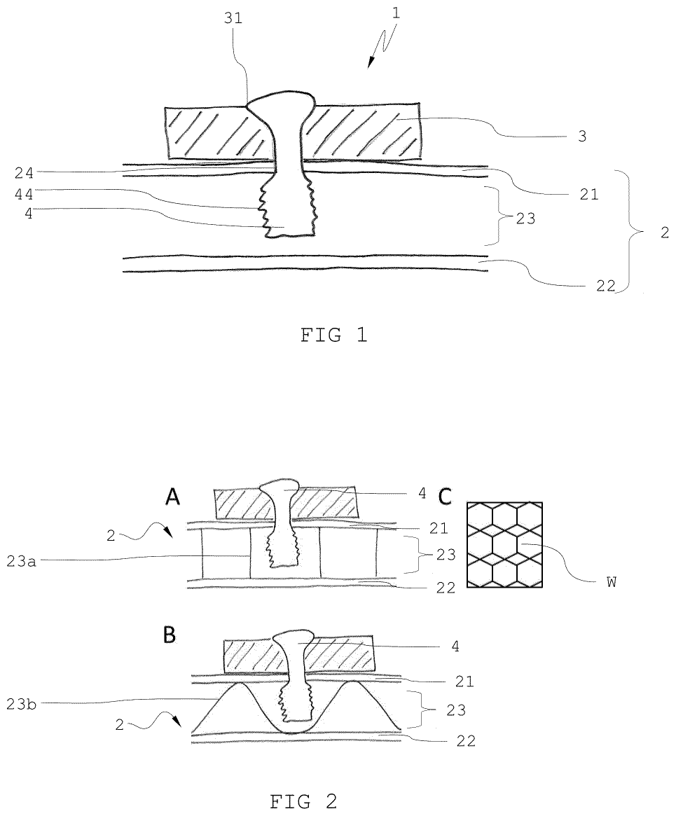

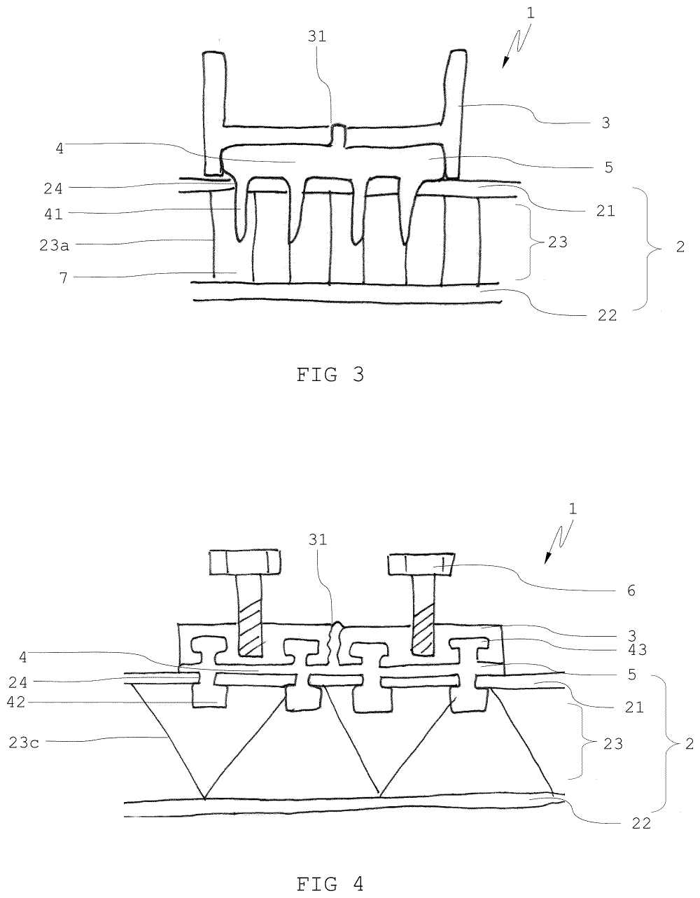

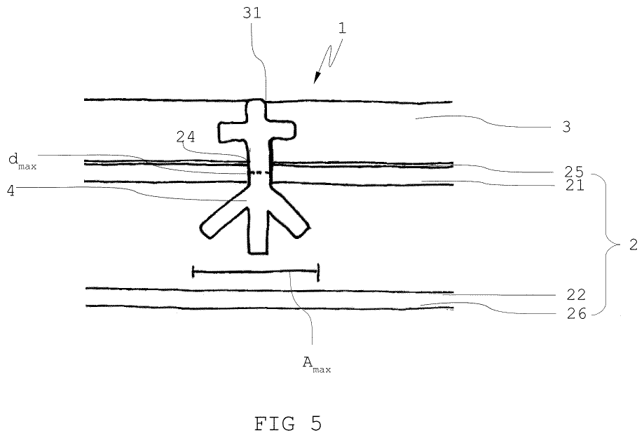

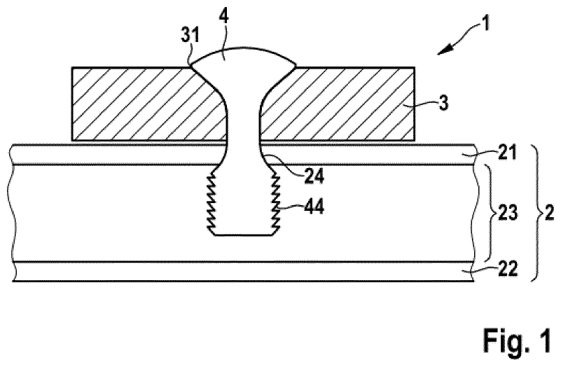

FIG. 1: shows a sectional sketch of a composite component of the invention, made of sandwich component and add-on part with polymer composition;

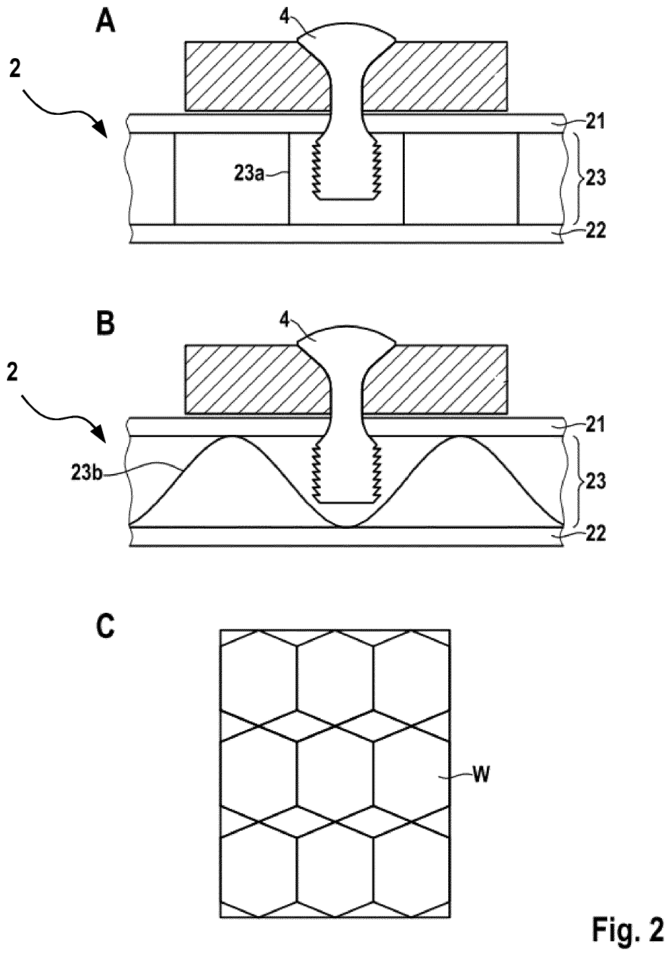

FIG. 2: shows a sectional view of various hollow-chamber structures of the interlayer of the component of FIG. 1; [A, B, C]

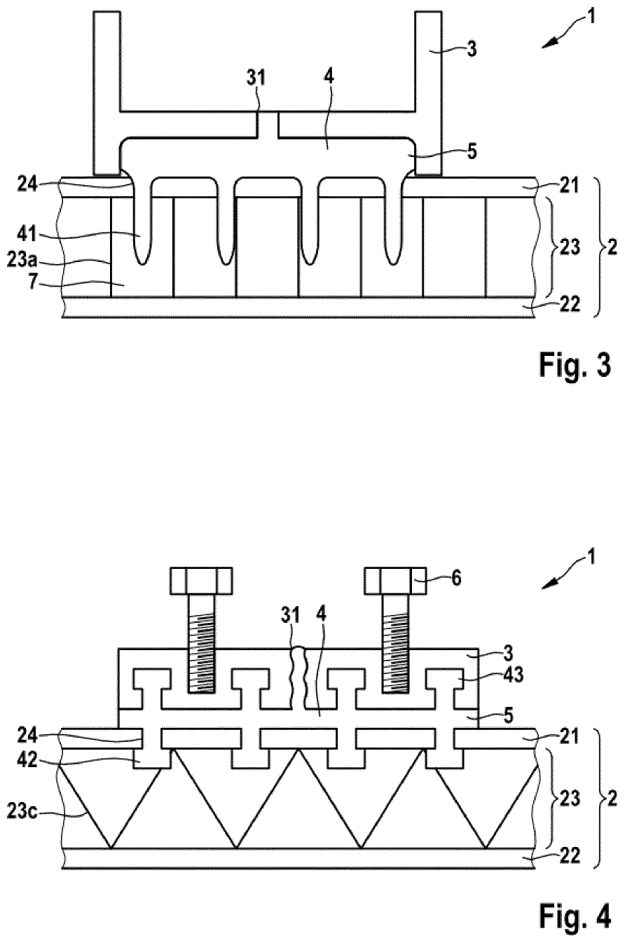

FIG. 3: shows a sectional sketch of another composite component of the invention;

FIG. 4: shows a sectional view of another composite component of the invention;

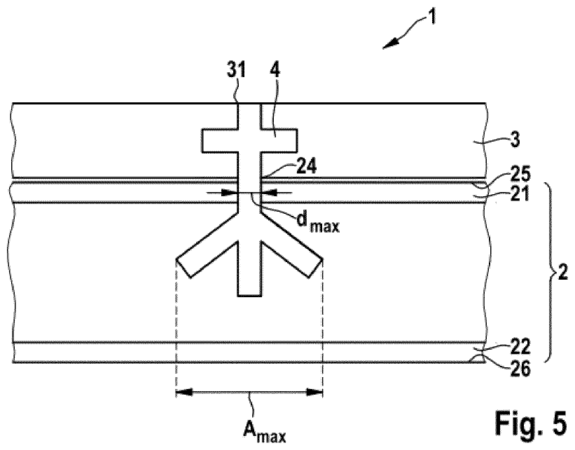

FIG. 5: shows a sectional view of another composite component of the invention.

Identical reference signs in the figures identify identical structural elements.

FIG. 1 shows a sectional view of a composite component 1 comprising a sandwich component 2 and an add-on part 3. The sandwich component 2 has a first outer ply 21 and a second outer ply 22. Between the first outer ply 21 and the second outer ply 22, an interlayer 23 is arranged. The interlayer 23 can by way of example consist of a foam material (not shown). The sandwich component 2 has an aperture 24 in the first outer ply. The add-on part 3 has an input aperture 31. The input aperture 31 and the aperture 24 are arranged in communication, in this case with parallel orientation. Between the input aperture 31 and the aperture 24, there is a hardened polymer composition 4 which was previously injected by way of the input aperture 31 and thus projects by way of the aperture 24 deeply into the interlayer 23. The teeth 44 of the hardened polymer composition 4 arose by virtue of the nature of the interlayer, and can vary with the material of the interlayer.

FIG. 2 shows the composite component 1 of FIG. 1 with different structure of the interlayer 23. In variant A, the interlayer 23 consists of honeycombs 23a. They can be filled honeycombs. In FIG. 2A, at least the honeycomb into which the hardened polymer composition 4 projects has been filled. In figure C, the honeycomb structure W is shown in plan view, where at least the upper outer ply 21 has been removed. In variant B, the interlayer 23 consists of individual corrugations 23b. Here again, at least the corrugation region in which the hardened polymer composition 4 projects has been filled.

FIG. 3 shows a sectional view of another composite component 1 of the invention, produced by the process of the invention. The sandwich component 2 comprises the first outer ply 21 and the second outer ply 22, and also the interlayer 23 in the form of honeycombs 23a. A foam 7 fills the resultant hollow-chamber structure. The first outer ply 21 has a plurality of apertures 24. An add-on part 3 has been applied to the sandwich component 2, with resultant formation of a cavity 5 between add-on part 3 and sandwich component 2. The input aperture 31 of the add-on part 3 leads into said cavity 5. A polymer composition has been charged through the input aperture 31 in a manner such that the hardened polymer composition 4 forms anchoring elements 41 in the sandwich component 2. Filling of the cavity 5 with the polymer composition has resulted in frictional connection of the sandwich component 2 to the add-on part 3. The arrangement of input aperture 31 and aperture 24 in communication has been achieved via the cavity 5, which provides connection between the two.

FIG. 4 shows another composite component 1 of the invention, produced by the process of the invention. The add-on part 3 and the sandwich component 2 likewise jointly form a cavity 5. This cavity 5 is filled with a polymer composition by way of the input aperture 31. The first outer ply 21 of the sandwich component 2 has four apertures 24 through which the polymer composition has passed into the interlayer 23. The hardened polymer composition 4 forms undercuts 42 in the sandwich component 2. These can be produced by drilling, milling, cutting, slotting, perforation, lasering, grinding, or a chemical or thermal method. Undercuts are mostly produced by using specialized tooling, for example milling machines, drills or cutters. The add-on part 3 has similar undercuts 43. The hollow-chamber structure of the interlayer 23 is formed in this design by pyramidal chambers 23c. On the add-on component 3, there are further connecting elements configured in the form of screws or threaded bolts 6, which serve for the fastening of further elements or components (not shown).

FIG. 5 shows another composite component 1, produced by the process of the invention. The polymer composition 4 has been introduced by way of the input aperture 31 and the aperture 24 into the sandwich component 2 in a manner such that the hardened polymer composition 4 extends across a maximal distance Aₘₐₓ parallel to the main surfaces 25 and 26 of the first outer ply 21 and second outer ply 22. The maximal distance Aₘₐₓ across which it extends here is greater than the maximal diameter dₘₐₓ of the aperture 24 of the sandwich component 2.

1-15. (canceled)

16. A process for the connection of an add-on part to a sandwich component, the process comprising the steps of:
a) providing a sandwich component comprising;
a first main surface with a first outer ply and a second main surface with a second outer ply, where at least one of the first outer ply and the second outer ply has at least one aperture; and
at least one interlayer, where the interlayer is positioned between the first outer ply and the second outer ply;
b) providing an add-on part with at least one first input aperture;
c) joining of the add-on part to the sandwich component in a manner such that the first input aperture of the add-on part and the at least one aperture of the sandwich component are arranged in communication; and
d) introducing a hardenable polymer composition by way of the first aperture of the add-on part into the at least one aperture of the sandwich component in a manner such that, after hardening of the polymer composition, the add-on part and the sandwich component are connected to one another by the polymer composition.

17. The process according to claim 16, where the first input aperture leads into a cavity between the add-on part and the sandwich component.

18. The process according to claim 16, where the polymer composition is an adhesive.

19. The process according to claim 16, where a pot life of the polymer composition is in a range from 1 to 15 sec.

20. The process according to cairn 16, where the polymer composition forms at least one of a coherent, interlocking and frictional connection.

21. The process according to cairn 16, where the polymer composition forms an undercut in the sandwich component.

22. The process according to claim 16, where the polymer composition has an undercut in the add-on part.

23. The process according to claim 16, where, within the sandwich component, a maximal distance (Aₘₐₓ) across which the polymer composition extends in a direction parallel to main surfaces of the sandwich component is greater than the maximal diameter (dₘₐₓ) of the aperture of the sandwich component.

24. The process according to claim 16, where the aperture of the sandwich component is selected from the group of a slot and a hole.

25. The process according to claim 16, where the at least one interlayer has a hollow-chamber structure.

26. The process according to claim 16, where the add-on part is a sheet, at least one of a connecting element and a fastening element, a spring system, an electrical element or a covering.

27. A composite component comprising a sandwich component and an add-on part, where the sandwich component has at least one preformed aperture in a first main surface with a first outer ply or in a second main surface with a second outer ply, where the add-on part has a preformed input aperture,
wherein the aperture of the sandwich component and the input aperture of the add-on part are arranged in communication and have been connected to one another by way of a hardened polymer composition.

28. The process according to claim 16, where the first outer ply of the first main surface is a first outer sheet and the second outer ply of the second main surface is a second outer sheet.

29. The process according to claim 18, where the adhesive is a two-component adhesive.

30. The process according to claim 24, where the aperture of the sandwich component is a circular hole.

31. The composite component according to claim 27, where the sandwich component has at least one preformed aperture in a first main surface with a first outer ply and at least one preformed aperture in a second main surface with a second outer ply.

32. The process according to claim 16, wherein the hardenable polymer composition is one of a chemically crosslinkable adhesive or a hotmelt adhesive.

33. The process according to claim 16, wherein the hardenable polymer composition comprises an isocyanate-containing component A and an amine-containing component B, where
the component A comprises an isocyanate-terminated prepolymer with isocyanate functionality ≥1.7; and
the component B comprises at least one di- and/or polyamine; and
where the stoichiometric ratio of isocyanate groups in component A to amine groups in component B is 0.5 to 1.2.

34. The process according to claim 33, wherein the component A comprises an isocyanate-terminated prepolymer with isocyanate functionality 1.7<f_{NCO}<3.
